(19) United States
(12) Patent Application Publication
(10) Pub. No.: US 2015/0161672 A1
(43) Pub. Date: Jun. 11, 2015

(54) Preventing Display of Age Inappropriate Advertising

(71) Applicant: Microsoft Corporation, Redmond, WA (US)

(72) Inventors: Jaeyeon Jung, Kirkland, WA (US); Suman K. Nath, Redmond, WA (US); Ravi Bhoraskar, Seattle, WA (US)

(73) Assignee: Microsoft Corporation, Redmond, WA (US)

(21) Appl. No.: 14/101,162

(22) Filed: Dec. 9, 2013

(51) Int. Cl. G06Q 30/02

(52) U.S. Cl. CPC G06Q 30/0269

(57) ABSTRACT

Advertisements are screened for age-appropriateness prior to inclusion and display within an application. An advertisement that is available for display within an application is analyzed to determine if either the advertisement itself or if a landing page for the advertisement contains content that is inappropriate for a target age of users such as children. Inappropriate content may include inappropriate language, inappropriate images, and requests for personal information without parental consent. The analysis may include textual analysis, image fingerprinting, and crowdsource analysis. If the advertisement and the landing page are both appropriate for display to the target age of users, the application displays the advertisement. If the advertisement or the landing page is inappropriate for display, the application does not display the advertisement but instead requests a new advertisement for analysis and potential display.

### BACKGROUND

Many software application developers are supported by advertising revenue from advertisements placed within applications. Often the software applications are designed to fetch advertisements from advertisement provider services and display the advertisements, such as in a banner. The selection of a particular advertisement by the advertisement provider services is typically outside the control of the application developers.

Many software applications are intended for use by children. An application developer may specifically design an application to be appropriate for children, but be frustrated by inclusion of advertisements that are inappropriate for children. Laws such as the Children's Online Privacy Protection Act (COPPA) may impose legal obligations on application developers to ensure that advertisements are appropriate for children. Industry self-regulation such as the Children's Advertising Review Unit (CARU) may also impose voluntary obligations on participating business to regulate the content of advertisements shown to children. Thus, application developers may desire a way to prevent their applications from showing advertisements that are inappropriate for children. This desire may be in tension with a business need to obtain revenue from advertising.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An application developer may modify its application to request evaluation of an advertisement for child-friendliness prior to displaying the advertisement within the application. When the application requests an application provider service to supply the application with an advertisement, the application obtains information about the advertisement. The application may send information about the advertisement to an advertisement evaluation system. If any aspect of advertisement is determined by the advertisement evaluation system to be inappropriate for the age of a target audience, the advertisement may be identified as inappropriate and the application may be given an option to block the advertisement.

A given advertisement contains both the contents of the advertisement itself and identification of any landing page reached by a user who “clicks” or otherwise interacts with the advertisement. The advertisement evaluation system may keep records of advertisements and landing pages that have been previously determined to be inappropriate for children. During evaluation of an advertisement, if either the advertisement itself or the landing page matches an entity in a list of content that is inappropriate for a target age-group, then the advertisement may be classified as age-inappropriate.

If the advertisement and the corresponding landing page are not included in a list of inappropriate content, the advertisement evaluation system may analyze the advertisement using machine intelligence and/or human intelligence. Text of the advertisement and its landing page may be automatically analyzed to determine if there are any words that suggest inappropriate content for an age group. Age groups may include, but are not limited to, children 18 and under, children 13 and under, people aged 13 to 19, children aged 5-9, people over 65 years old, etc. The age group used for screening appropriateness of advertisements may be the same age group of target users for the application. For example, an application created for use by children aged 8 to 13 may have advertisements in that application screened for age-appropriateness for the same age group of 8 to 13.

Also, images found in the advertisement and on the landing page may be automatically compared to a database of known inappropriate images by using image fingerprinting to determine if images in the advertisement, or in the landing page, are the same as or similar to a known inappropriate image. Machine learning-based algorithms (such as skin tone detection) can also be employed to judge appropriateness of an image for a target age group. Crowdsourcing techniques may take advantage of human intelligence by providing questions to human evaluators that ask about age-appropriateness of the advertisement and/or the landing page.

Results from evaluation of the text, images, and crowdsourcing results may be combined to determine if the advertisement is appropriate for the target age group. The application may then use the results of that determination to either accept the advertisement and display it, thereby receiving corresponding advertising revenue, or to reject the advertisement and request a new advertisement that will then be evaluated prior to display. Rejected advertisements are blocked before ever being displayed to users. This prevents display of inappropriate content to children.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 shows an illustrative architecture for evaluating advertisements prior to inclusion in applications.

FIG. 2 shows an illustrative diagram of contents of an advertisement.

FIG. 3 shows an illustrative block diagram of the advertisement evaluation system from FIG. 1.

FIG. 4 shows an illustrative block diagram of the end-user device from FIG. 1.

FIG. 5 shows an illustrative list of advertisements and landing pages.

FIG. 6 shows an illustrative survey page for collecting information from human evaluators.

FIG. 7 shows an illustrative process for determining if an advertisement is inappropriate for children.

FIGS. 8A and 8B show an illustrative process for determining if an advertisement should or should not be displayed in an application.

### DETAILED DESCRIPTION

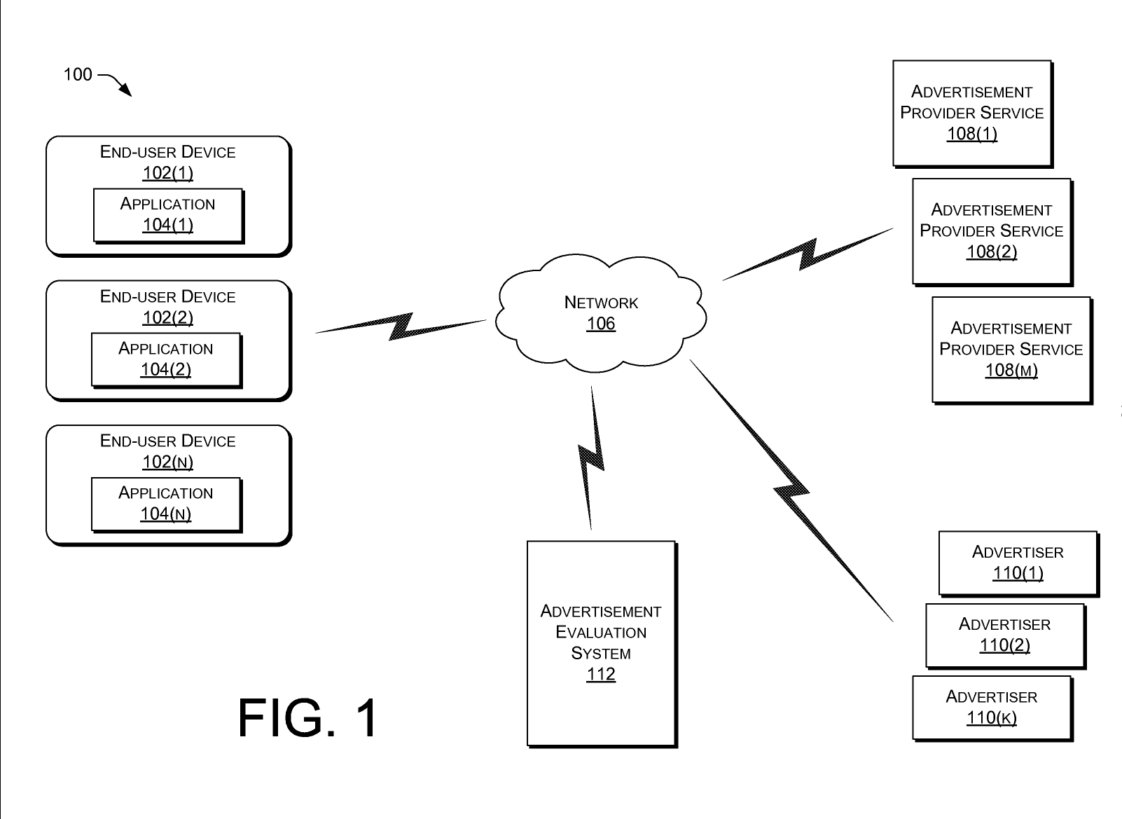

FIG. 1 shows an illustrative architecture 100 where one or more end-user devices 102(1), 102(2), . . . 102(n) run applications 104(1), 104(2), . . . 104(m). The end-user devices 102(1)-102(n) may be implemented as any type of computing device such as a desktop computer, a tablet computer, a smart phone, a gaming console, a set-top box, a personal digital assistant, and the like. The respective end-user devices 102(1)-102(n) may each be the same or different type of computing device as the other end-user devices 102(1)-102(n). The applications 104(1)-104(m) may be any type of computer application or mobile app such as a game, an operating system, a utility, an educational application, a productivity application, or the like. In some implementations, one or more of the applications 104(1)-104(m) may be an application designed and/or intended for use by children. The target age group is referred in this disclosure as being “children” which includes any range or one or more sub-ranges of ages between 0 and the age of majority in the relevant country or jurisdiction (e.g., 18 years old, 21 years old, etc.). The definition of applications 104(1)-104(m) also includes webpages and user-interface menu screens such as displayed by a game console or set-top box. The respective applications 104(1)-104(m) may each be the same or different applications. The end-user devices 102(1)-102(n) are collectively referred to as end-user device 102 and the applications 104(1)-104(m) are collectively referred to as application 104.

An end-user device 102 may communicate via a network 106 with one or more advertisement provider services 108(1), 108(2), . . . 108(j). The advertisement provider services 108(1)-108(j) are collectively referred to as advertisement provider service 108. The network 106 may be implemented as any type of communications network such as a local area network, a wide area network, a mesh network, and ad hoc network, a peer-to-peer network, the Internet, a cable network, a telephone network, and the like. The advertisement provider service 108 selects an advertisement and provides information about the selected advertisement to the application 104. The application 104 may present the advertisement inside the application such as, for example, a banner ad. A developer, distributor, producer, creator, marketer, etc. of the application (hereinafter, “application developer”) may receive advertisement revenue from the advertisement provider service 108 based on the display of the advertisement and based on users who interact (e.g., click on) with the advertisement. Pre-existing advertisement agreements or contracts between application developer and the advertisement provider service 108 may determine the payment amounts and payment conditions for any advertising revenue provided to the application developer. Selection of an advertisement by the advertisement provider service 108 may be based on keywords or other information provided by the application developer when requesting advertising services from the advertisement provider service 108. Examples of advertisement provider services 108 include, but are not limited to, AdMob by Google®, DoubleClick by Google®, and Bing ads by Microsoft®.

The application 104 may send a request to the advertisement provider service 108 to fetch information about an advertisement. The advertisement provider service 108 may return information to the application 104 such as a universal resource locator (URL) for images found in the advertisement and a URL that is reached by “clicking through” or otherwise interacting with the advertisement.

Content of the advertisement itself may be provided by an advertiser 110. In the architecture 100, multiple advertisers 110(1), 110(2), . . . 110(k) may supply the advertisements that ultimately displayed on the end-user device 102 within the application 104. The advertisers 110(1)-110(k) may supply the advertisements from advertisement servers or other computing systems via the network 106. A given advertisement provider service 108 may obtain advertisements from multiple different advertisers 110(1)-110(k). Similarly, a given advertiser 110 may supply advertisements to multiple different advertisement provider services 108(1)-108(j). Although shown as separate in architecture 100, an advertisement provider service 108 and advertiser 110 may be combined to form a single entity and/or be situated within a same computing system.

Thus, the application 104, through an agreement with the advertisement provider service 108, obtains advertisements from an advertiser 110 and possibly advertising revenue from the advertisement provider service 108. However, the application developer may have limited control over which specific advertisements are included in the application 104. The lack of control may expose the application developer to negative legal or business consequences as a result of displaying inappropriate advertisements in an application for children. Thus, the application developer will benefit from a solution that enables it to access revenue streams from conventional advertisement provider services 108 yet also provides protection against inadvertent display of inappropriate advertisements within applications 104 that are used by children.

The advertisement evaluation system 112 may function as a screening system that evaluates advertisements and provides the application 104 with an opportunity to decline a given advertisement prior to displaying the advertisement within the application 104. The advertisement evaluation system 112 may screen advertisements for child friendliness or for the presence of content that is inappropriate to display to children. In other implementations, the advertisement evaluation system 112 may additionally or alternatively screen advertisements for other undesirable characteristics apart from child unfriendliness. Features of the advertisement evaluation system 112 and the end-user device 102 are discussed in greater detail below.

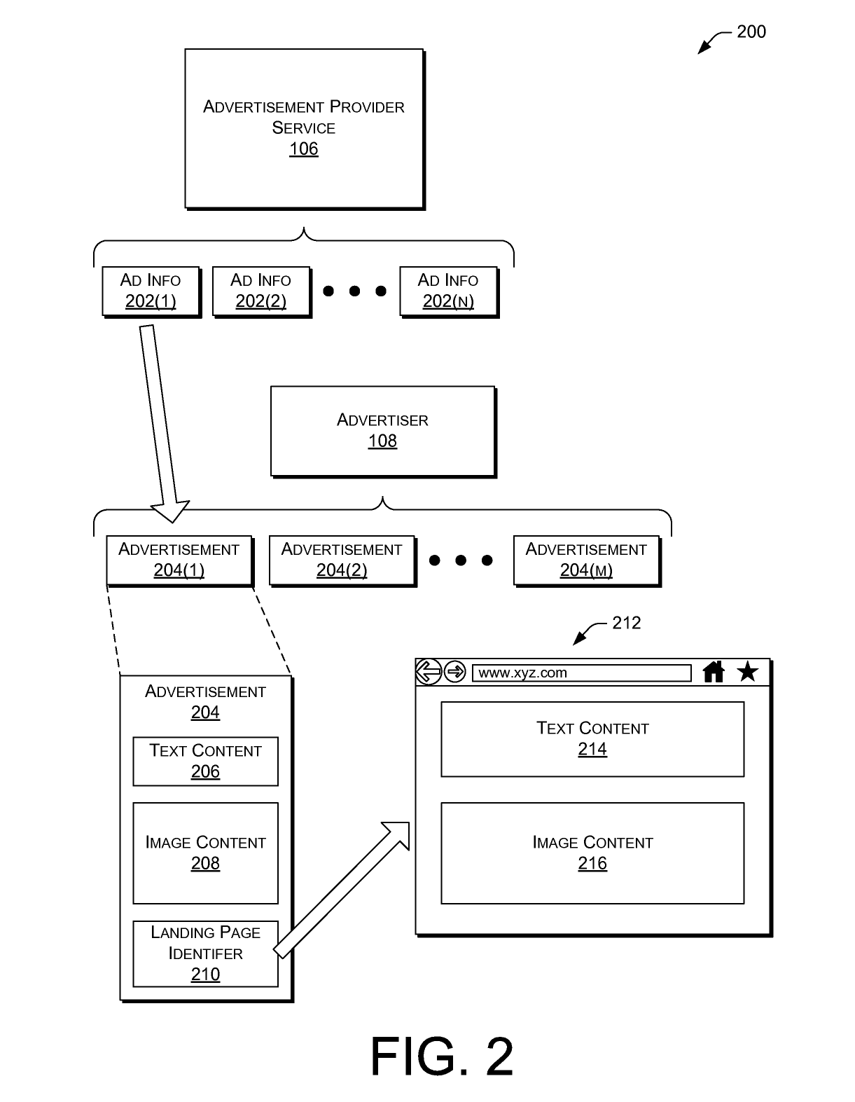

FIG. 2 shows a diagram 200 of a relationship between the advertisement provider service 108, advertisement information (ad info) 202 and an advertisement 204. The advertisement provider service 108 may aggregate ad info 202(1), 202(2), . . . 202(n) about a plurality of different advertisements 204(1), 204(2), . . . 204(m). A given compilation of ad info 202(1) may have a direct and one-to-one correspondence with a given advertisement 204(1). The ad info 202 may provide sufficient information for the application 104 or the advertisement evaluation system 112 to fetch the advertisement 204 from the advertiser 110. Thus, a computing system that has access to the ad info 202 may, through the network 106, obtain the actual advertisement 204.

The advertisement 204 may contain multiple logical parts. Text content 206 in the advertisement 204 may represent words, characters, or other representation of a language that is generally human-readable when presented in the advertisement 204 as displayed to a user. For example, the advertisement 204 may include the text content 206 “Buy this product now!” Image content 208 in the advertisement 104 may include a picture, drawing, or other similar non-text digital content. For example, the advertisement 204 may include a picture of a new product. The advertisement 204 may include a landing page identifier 210 of an associated landing page 212. In some implementations such as a World Wide Web-based implementation, the landing page identifier 210 may be a web address or universal resource locator (URL) of the landing page 212. For example, the landing page identifier 210 for the landing page 212 may be www.xyz.com. Not every advertisement 204 necessarily includes text content 206, image content 208, and a landing page identifier 210. For example, text-only advertisements may lack image content 208. As a further example, an advertisement may solicit a user to call a phone number or visit a retail location rather than providing a landing page identifier 210.

For those advertisements 204 that are associated with a landing page 212, the landing page 212 may itself have both text content 214 and/or image content 216. The text content 214 and the image content 216 found in the landing page 212 may be similar or different from the text content 206 and the image content 208 found in the corresponding advertisement 204. When evaluating an advertisement 204 for the presence of content that is inappropriate for children, any content inappropriate for children generally results in the advertisement 204 being categorized as inappropriate. Thus, each of the text content 206 of the advertisement 204, the image content 208 of the advertisement 204, the text content 214 of the landing page 212, and the image content 216 of the landing page 212 may be evaluated by the advertisement evaluation system 112 using techniques described below. If any of those four types of content are found to be inappropriate for children, even if other content is appropriate for children, the advertisement 204 may be classified as inappropriate for children and blocked from display in applications 104.

Both the advertisement 204 the corresponding landing page 212 may include other types of content not shown in diagram 200 such as, for example, audio or video content. Other types of content may be omitted from the analysis performed by the advertisement evaluation system 112 or evaluated using techniques similar to those applied to text content 206 and 214 and image content 208 and 216. For example, audio content may be converted to text using a speech-to-text system and then analyzed in an analogous manner to text content 206 and 214. Similarly, video content may be converted to one or more images and those images obtained from the video content may be analyzed in an analogous manner to image content 208 and 216. As used herein, “advertising content” includes all types of content such as text, audio, image, video, as well as any other type of content used to advertise a good or service to one or more human recipients of the advertising content.

### Illustrative Advertisement Evaluation System and End-User Device

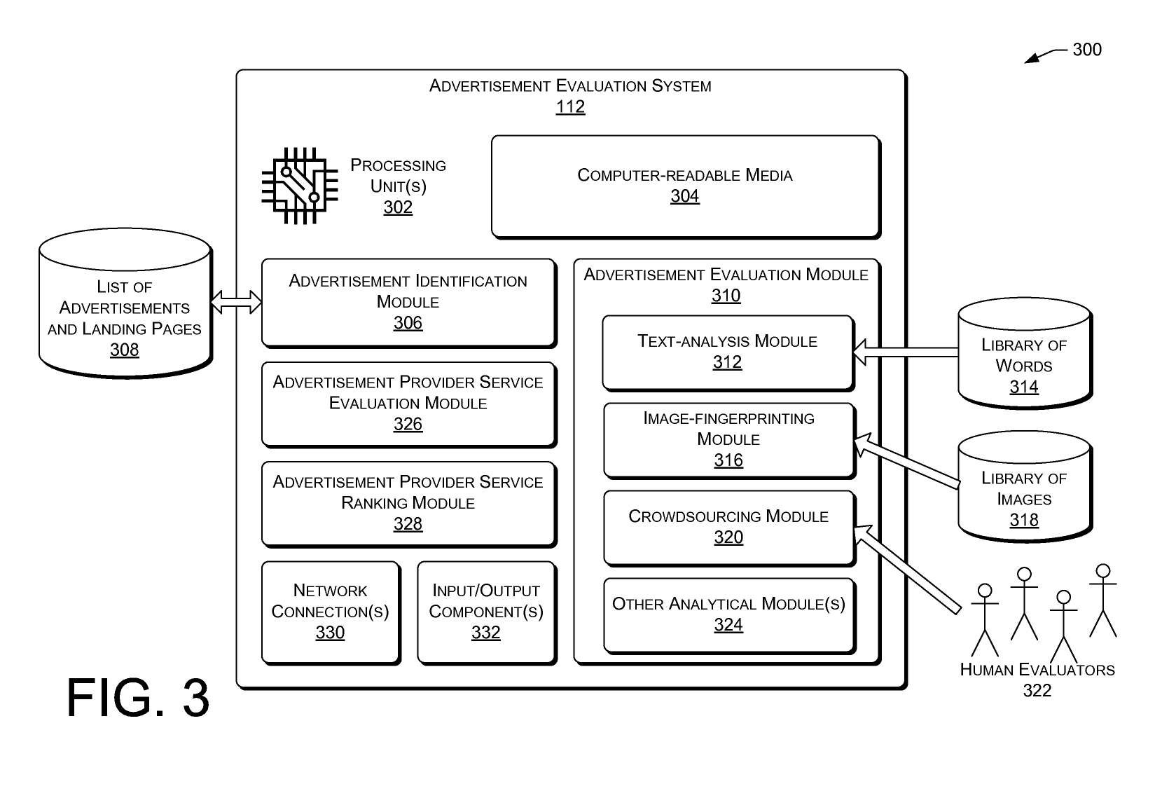

FIG. 3 shows an illustrative block diagram 300 of components that may be included in the advertisement evaluation system 112 of FIG. 1. The advertisement evaluation system 112 contains one or more processing unit(s) 302 and computer-readable media 304 both of which may be distributed across one or more physical or logical locations. The processing unit(s) 302 may include any combination of central processing units (CPUs), graphical processing units (GPUs), single core processors, multi-core processors, application-specific integrated circuits (ASICs), and the like. One or more of the processing unit(s) 302 may be implemented in software and/or firmware in addition to hardware implementations. Software or firmware implementations of the processing unit(s) 302 may include computer- or machine-executable instructions written in any suitable programming language to perform the various functions described. Software implementations of the processing unit(s) 302 may be stored in whole or part in the computer-readable media 304.

The computer-readable media 304 may include removable storage, non-removable storage, local storage, and/or remote storage to provide storage of computer readable instructions, data structures, program modules, and other data. Computer-readable media includes, at least, two types of media, namely computer-readable storage media and communications media. Computer-readable storage media includes volatile and non-volatile, removable and non-removable media implemented in any method or technology for storage of information such as computer-readable instructions, data structures, program modules, or other data. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer-readable storage media and communication media are mutually exclusive.

The block diagram 300 shows multiple modules included within the advertisement evaluation system 112. These modules may be implemented in software and alternatively, or additionally, implemented, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

An advertisement identification module 306 receives identification of an advertisement 204 from one of the end-user devices 102. Identification of an advertisement 204 may be obtained using the ad info 202 received by the application 104 of the end-user device 102 from the advertisement provider service 108. The advertisement identification module 306 may determine what, if any, landing page 212 is reached by a user who interacts with the advertisement 204. The advertisement identification module 306 may obtain the advertisement 204 and the landing page 212 from the advertiser 110 via the network 106. The advertisement evaluation system 112 may then proceed to evaluate the advertisement 204 and the landing page 212 for characteristics such as child friendliness.

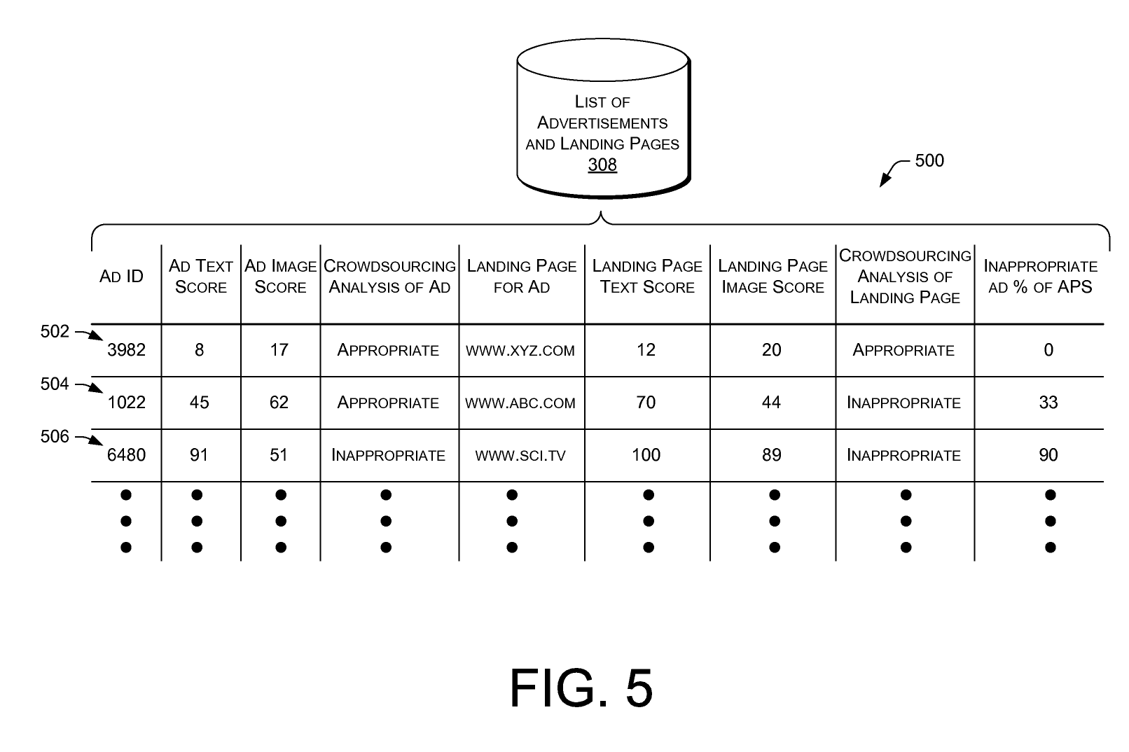

Both the advertisement 204 and any associated landing page 212 may be compared with a list of advertisements and landing pages 308 to determine if either the advertisement 204 or the landing page 212 has been previously identified as being inappropriate for children. This list 308 may be configured as a blacklist that includes advertisements 204 and landing pages 212 which have been previously determined to be inappropriate for children. The previous determinations may also indicate the specific age group or sub-group(s) for which the advertisements 204 and/or landing pages 212 are inappropriate. However, the list 308 may also be configured to include advertisements 204 and landing pages 212 that have previously been identified as appropriate to display to children (this list may also have groupings of different ages of children). In some implementations, the list 308 may include a record of advertisements 204 and landing pages 212 that have been evaluated by the advertisement evaluation system 112 along with the results of such evaluation. Illustrative content of a list of advertisements and landing pages 308 is shown in FIG. 5 and discussed below.

The advertisement identification module 306 may also determine which advertisement provider service 108 supplied the ad info 202 about the advertisement 204. This identification can link a given advertisement 104 with the source (i.e., advertisement provider service 108) that provided the advertisement 104. Due to limited supply of advertisements 204 to an advertisement provider service 108, business arrangements between an advertisement provider service 108 and an advertiser 110 (e.g., one advertiser 110 pays more to have its advertisement 204 promoted than other advertisers 110), or other reasons, a given advertisement provider service 108 may, for a period of time, supply only one or a few different advertisements 204. Thus, using techniques discussed below, knowledge of which advertisement provider service 108 is providing an advertisement 104 may be used to abbreviate the analysis and determine if a given advertisement 104 is inappropriate for children based on the past advertisements 104 provided by that advertisement provider service 108.

An advertisement evaluation module 310 generates evaluations for advertisements 204 submitted to the advertisement evaluation system 112. In some indentations, the evaluations may be presented as a binary result indicating that an advertisement 204 is either appropriate or inappropriate for children. In other implementations, the evaluations may be presented as an appropriateness score that represents either a degree of appropriateness/inappropriateness or a probability that a given advertisement 204 is appropriate/inappropriate for children. The appropriateness score may be configured as a continuous variable that could range, for example, from 0 to 100. In implementations in which output from the advertisement evaluation module 310 is an appropriateness score, applications 104 may be configured with thresholds that determine which score level for an advertisement 204 causes the application 104 to block the advertisement 204. An advertisement 204 may be associated with multiple score levels each for different types of “bad” content (e.g., sexual content, violent content, content that promotes gambling, etc.) Application developers may independently set the threshold score levels so that different applications 104 have different thresholds from other applications and different thresholds for different types of “bad” content. Different thresholds may also be set for different age groups or sub-groups of children. Workable threshold levels may be identified through training and/or trial-and-error.

Results generated by the advertisement evaluation module 310 may be based in part on the results from a text-analysis module 312. The text-analysis module 312 may determine if an advertisement 204 or landing page 212 includes text content 206 or 214 that is identified as inappropriate for children. A library of words 314 may store words and phrases that have been previously identified as being inappropriate for children of one or more ages. Conventional algorithms may be used to analyze the text content 206 or 214 received by the text-analysis module 312 in order to determine if that text includes any words or phrases found in the library of words 314. Thus, the library of words 314 may be implemented as a blacklist of “bad” words that, if found, result in the categorization of input text as being inappropriate for children. However, in some implementations the library of words 314 may also include phrases that result in otherwise “bad” words being whitelisted or indicated as appropriate for display to children (e.g., “naked” may be “bad” but “naked eye” is not bad). Thus, the context may be used to determine the appropriateness or inappropriateness of text content 206 or 214. The library of words 314 may be continually or periodically updated as language changes and new words with inappropriate meanings come into use. The ultimate determination of whether a word is appropriate or inappropriate for children may be made by human editors that select the words and phrases for inclusion in the library of words 314.

The text-analysis module 312 may output a text-based probability score that the advertisement 204 is inappropriate for children. Alternatively, the text-analysis module 312 may output a binary result indicating that the advertisement 204 is appropriate or inappropriate for children based on the presence of one or more words from the text content 206 or 214 of the advertisement 204 or landing page 212 being found in the library of words 314.

The text-analysis module 312 may categorize “bad” words into a number of different categories or bins. For example, the different categories of “bad” words may include: words related to nudity, pornography, or sexuality; words that use offensive language, swearwords, or hate speech; words that describe violence or horror; words that mention alcohol, tobacco, or other drugs; words related to gambling; or words that suggest collection of personal information. Each of the categories is merely illustrative and additional categories may be included or any of the listed categories may be combined in whole or part. Text analyzed by the text-analysis module 212 may be categorized or ranked according to category. For example, input text may receive one ranking for words related to nudity, pornography, or sexuality and a different ranking for words related to gambling. Application developers may utilize this category-specific ranking to tailor the types of text content 206 and 214 which is excluded from being displayed within an application 104. For example, one application 104 may block advertisements that include words related to offensive language, swearwords, or hate speech while a different application 104 may filter out advertisements that include words related to alcohol, tobacco, or other drugs. The various category-specific rankings may be used to tailor the permissible content for different age groups of children.

In some implementations, the library of words 314 and the text-analysis module 312 may be configured to filter text content 206 and 214 based on other criteria. For example, a company may choose to use the advertisement evaluation system 112 to exclude advertisements about competitors' products rather than, or in addition to, excluding advertisements that are inappropriate for children. Thus, in such an implementation, words that are associated with the competitor company may be designated as “bad” words in the library of words 314.

An image-fingerprinting module 316 may also screen advertisements 204 and landing pages 212 to filter out inappropriate content. The image-fingerprinting module 316 may use known image-analysis techniques to determine if an advertisement 204 or landing page 214 includes image content 208 or 216 that is the same or similar to an image identified as inappropriate for children. Images that are inappropriate for children may be obtained from a library of images 318. The library of images 318 may be similar to the library of words 314 in that the library of images 318 may have images classified into one of multiple categories/bins based on why the image is deemed inappropriate for children. For example, images depicting nudity and images depicting weapons may be classified in separate categories/bins. The library of images 318 may be populated with images that have been manually identified as being inappropriate for children and also manually identified as belonging to a particular category of image.

Results generated by the image-fingerprinting module 316 may be a binary classification of an advertisement 204, or its associated landing page 214, as including at least one image that is inappropriate for children or being completely free of images that are inappropriate for children. Alternatively, the image-fingerprinting module 316 may generate an image-based probability score representing a probability that an advertisement 204 or landing page 214 is inappropriate for children. The image-based probability score may be similar to the text-based probability score. Thus, the image-based probability score may be a continuous variable and there may be separate scores for distinct categories of “bad” image content 208 and 216. Thus, application developers may design applications 104 to differentially block or permit image content 208 or 216 based on the category or bin in which an image is included. For example, one application 104 may permit advertisements 204 or landing pages 212 that include image content 208 or 216 related to weapons or violence while a different application 104 may choose to block advertisements 204 or landing pages 212 that include image content 208 or 216 related to weapons or violence.

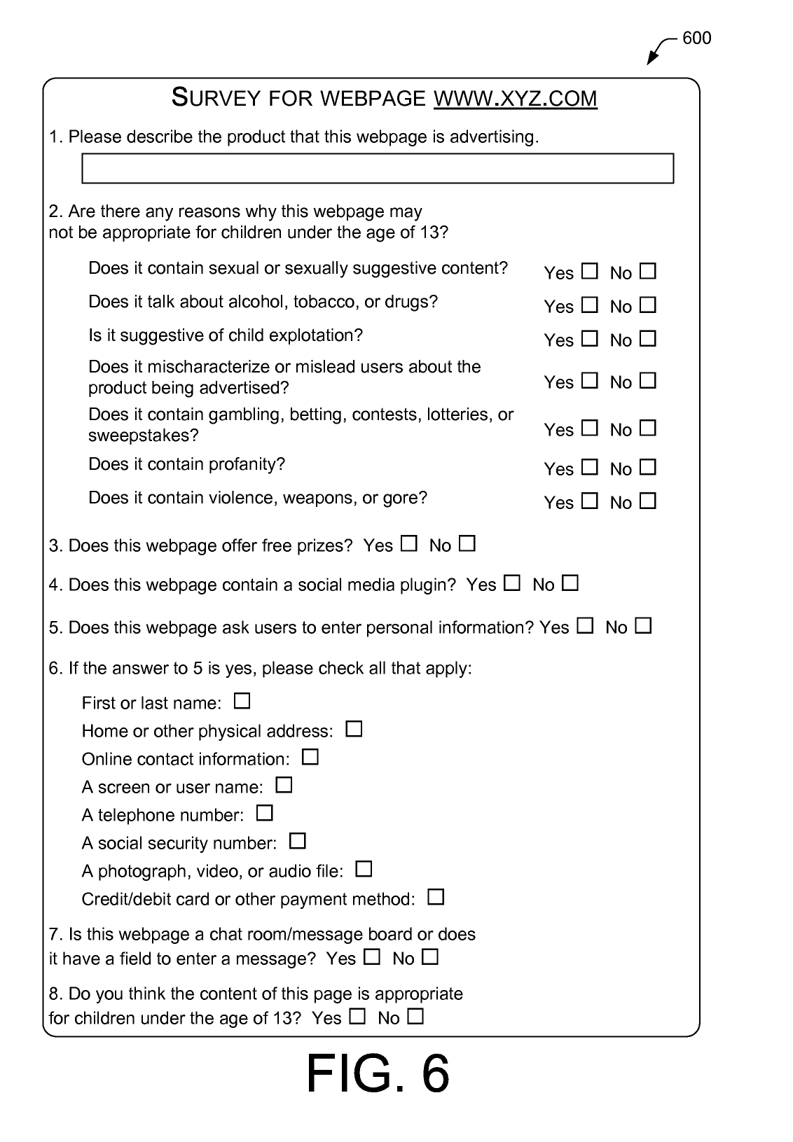

A crowdsourcing module 320 transmits one or more queries to a plurality of human evaluators 322 asking for subjective evaluation of appropriateness of an advertisement 204 and/or landing page 212 for children. The crowdsourcing module 320 receives responses to the query from the human evaluators 322. The query may be provided as a list of one or more questions, a survey, or the like. One illustrative query is shown in FIG. 6. Different individuals out of the human evaluators 322 may provide different answers to the same question. Thus, the results obtained by the crowdsourcing module 320 may not be a unified or consistent set of answers. The crowdsourcing module 320 is also configured to determine a collective evaluation of appropriateness of the advertisement 204 and/or landing page 212 for children from an aggregation of the responses from human evaluators 322. Depending on the format of the questions submitted to the human evaluators 322, the collective evaluation of the responses may represent an average response value (e.g., in response to questions that are answered by a numerical value), a most frequent response (e.g., in response to questions from which the human evaluators 322 choose from a defined set of possible answers), or any other known technique for aggregating and analyzing human-generated response data.

In some implementations, the query may simply ask the human evaluators 322 to view an advertisement 214 and/or a landing page 212 and then answer whether or not it is appropriate for children, children of a specific age, etc. The results generated by the crowdsourcing module 320 may be a binary result such as, for example, indicating that the advertisement 214 is inappropriate for children if more than 50% of the responses indicate that the advertisement 214 is inappropriate for children. In other implementations, the crowdsourcing module 320 may output a probability score based on the human analysis that indicates a probability the advertisement 204 or landing page 212 is inappropriate for children. Any known statistical technique for generating a probability may be used. In one example, the percent of respondents to the query that indicate an advertisement 204 is inappropriate for children may be used as the probability that the advertisement 204 is inappropriate for children. Thus, if 80% of human evaluators 322 replied that a given advertisement 204 is inappropriate for children, then the human-analysis-based probability score would be 80 or 80% (or conversely 20 if the metric represents appropriateness).

Use of human evaluators 322 and crowdsource analysis allows the advertisement evaluation module 310 to identify features of advertisements 204 and landing pages 214 that may be difficult to discover with the text-analysis module 312 and the image-fingerprinting module 316. For example, asking the human evaluators 322 to provide their subjective evaluations of appropriateness of an advertisement 204 for or landing page 214 may identify nuance, innuendo, slang, combinations of text and images, etc. that are inappropriate for children but difficult to identify by automatic, computer-based analysis. The crowdsourcing module 320 may also query the human evaluators 322 to determine if an advertisement 204 or a landing page 214 asks for personal information. Collecting personal information from children under 13 may be regulated by laws such as the Children's Online Privacy Protection Act (COPPA) thus it may be important for application developers to identify advertisements 204 that request personal information without parental consent.

Other analytical module(s) 324 may evaluate an advertisement 204 and/or a corresponding landing page 214 for other features instead of or in addition to child-appropriateness. For example, the other analytical module(s) 324 may evaluate landing pages 214 the presence of viruses, malware, phishing, and the like. These types of analysis may be performed by any known techniques for identifying viruses, malware, or phishing. Moreover, human intelligence access to the crowdsourcing module 320 may utilize queries with questions directed towards the presence of phishing or other activities. The other analytical module(s) 324 may be configured as desired to provide the advertisement evaluation module 310 with functionality to screen advertisements 204 or any type of content for functionality beyond that specifically described herein using any combination of automated and machine analysis and/or crowdsourcing and human intelligence.

The advertisement evaluation module 310 generates evaluation of an advertisement 204 based on the results from one or more of the text-analysis module 312, the image-fingerprinting module 316, the crowdsourcing module 320, and other analytical module(s) 324 if present. Some advertisements 204, and the corresponding landing pages 212, may lack either text content 206 and 214 or image content 208 and 216. Thus, the text-analysis module 312 or the image-fingerprinting module 316 may not be used if there is no content for the module to analyze. The crowdsourcing module 320 may require several minutes or hours to receive a sufficient number of responses from human evaluators 322. Thus, when a new advertisement 204 is first reviewed by the advertisement evaluation module 310, an initial evaluation may be based only on real-time analysis provided by the text-analysis module 312 and the image-fingerprinting module 316. The appropriateness score for the advertisement 204 may also change if, for example, the information obtained from the crowdsourcing module 320 results in a different evaluation that the scores provided initially by the text-analysis module 312 and/or the image-fingerprinting module 316.

The appropriateness score generated by the advertisement evaluation module 310 may be an aggregate appropriateness score that is based on the text-based probability score generated by the text-analysis module 312, the image-based probability score generated by the image-fingerprinting module 316, and/or the human-analysis-based probability score generated by the crowdsourcing module 320. Thus, the aggregate appropriateness score may be a single number representing the appropriateness (or inappropriateness) of displaying the advertisement 204 to children. The aggregate appropriateness score may be based on an average of the three separate scores, a weighted average, a median score, a highest score, or a lowest score. For example, the weights applied to the text-based probability score, the image-based probability score, and the human-analysis-based probability score may be determined by experimental comparison of the scores to manual identification of appropriate/inappropriate advertisements 204.

In some implementations, a single aggregate appropriateness score may be provided by the advertisement evaluation system 112 to an application 104. In other implementations, one or more of the text-based probability score, the image-based probability score, and the human-analysis based probability score may be separately provided by the advertisement evaluation system 112 to the application 104 in addition to, or in place of, the aggregate appropriateness score.

The advertisement evaluation system 112 may also include an advertisement-provider-service evaluation module 326 and advertisement-provider-service ranking module 328. Given that the advertisement identification module 306 may track the advertisement provider services 106 that provide various advertisements 204 the advertisement-provider-service evaluation module 326 may log instances that an advertisement provider service 108 provides an advertisement 204 that is inappropriate for children. By tracking how many advertisements 204 coming from a given advertisement provider service 108 are inappropriate for children, the advertisement provider-service evaluation module 326 may determine a percentage of total advertisements provided by the advertisement provider service 108 that are inappropriate for children. Thus, each advertisement provider service 108 that is evaluated by the advertisement evaluation system 112 may be associated with a percentage or probability indicating how likely a randomly selected advertisement from that advertisement provider service 108 will be inappropriate for children. If the advertisement evaluation system 112 provides analysis of advertisements 204 for hundreds, thousands, or tens of thousands of different applications 104, the advertisement evaluation system 112 may be able to provide a global analysis that is based on a larger set of data that would be available to any single application developer or application 104.

The advertisement-provider-service ranking module 328 may communicate various advertisement provider services 106 child-appropriateness to the end-user devices 102. The child-appropriateness may be represented as the percentage of total advertisements provided by an advertisement provider service 108 over a certain time window that are inappropriate for children. Thus, the advertisement-provider-service ranking module 328 may expose or share the output from the advertisement-provider-service evaluation module 326. The end-user devices 102 and applications 104 running on those devices may use the percentages in selecting an advertisement provider service 108 from which to request advertisements 204. Thus, the advertisement-provider-service evaluation module 326 and the advertisement-provider-service ranking module 328 may enable the applications 104 to seek advertisements from those advertisement provider services 106 that are most likely to provide child-friendly advertisements 204.

The advertisement evaluation system 112 may also include one or more network connections 330 that provide access to the network 106 and one or more input/output components(s) 332 such as a keyboard, a pointing device, a touchscreen, a microphone, a display, a speaker, a printer, and the like.

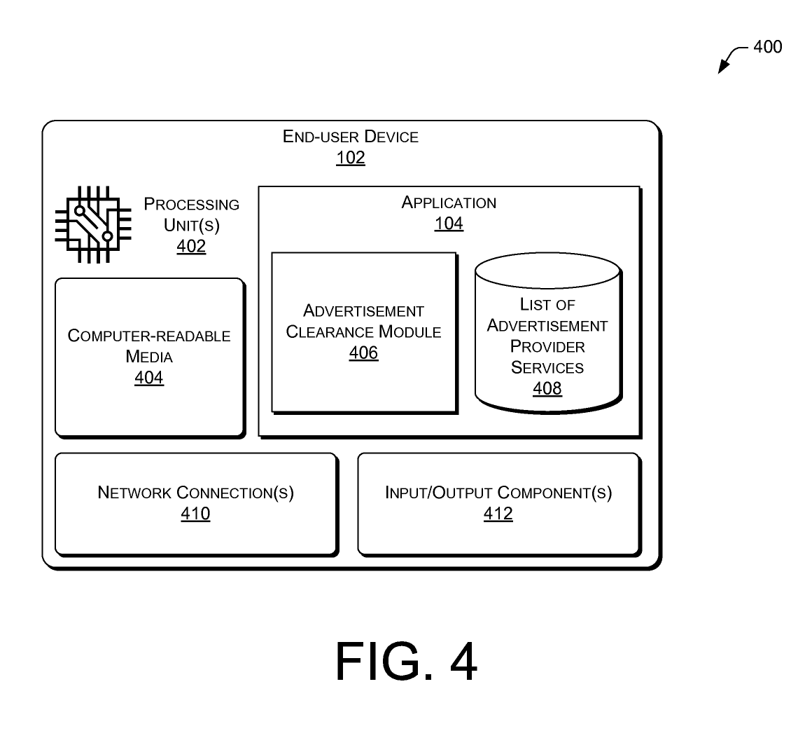

FIG. 4 shows an illustrative block diagram 400 of components that may be included in one of the end-user devices 102 of FIG. 1. An end-user device 102 may contain one or more processing unit(s) 402 and computer-readable media 404. The processing unit(s) 402 and the computer-readable media 404 may be the same or similar to the processing unit(s) 302 and the computer-readable media 304 shown in FIG. 3.

The application 104 present on the end-user device 102 may be implemented as software stored in the computer-readable media 404, as firmware, or as a hardware component. The application 104 may include an advertisement clearance module 406 that communicates with the advertisement evaluation system 112 which determines whether or not an advertisement 204 is cleared for display within the application 104. Thus, the advertisement evaluation system 112 and the advertisement clearance module 406 may function together in order to both identify and block advertisements 204 that are inappropriate for display to children. In other implementations, the advertisement clearance module 406 may function to evaluate the advertisement 204 for criteria other than child-appropriateness, such as, for example, promotion of a competitors' business, links to software or webpages containing viruses, etc.

For a given advertisement 204, the advertisement clearance module 406 may receive an evaluation from the advertisement evaluation system 112. As mentioned above, the evaluation may be a binary answer categorizing an advertisement 204 as either appropriate for display to children or inappropriate for display to children. Advertisements that are inappropriate for display to children may be blocked by the advertisement clearance module 106 from being displayed within the application 104. The advertisement clearance module 406 can thus act as a shim layer between a request for an advertisement and display of the requested advertisement 204. Advertisements that are appropriate for display to children may be cleared for display within the application 104 and displayed in a conventional manner. Thus, once an advertisement 204 is cleared, the application 104 may present the advertisement 204 (e.g., as a banner ad etc.) in the same way as a conventional application that does not screen for child appropriateness.

As mentioned above, the advertisement evaluation system 112 may also provide evaluations of advertisements 204 as numbers that represent probabilities of an advertisement 204 being appropriate/inappropriate for display to children. The application developer may choose to set its own thresholds for inclusion or exclusion of advertisements 204 using the advertisement clearance module 406. For example, an application developer may set a threshold that blocks any advertisement 204 which has an aggregate appropriateness score indicating less than a 75% probability that the advertisement 204 is appropriate for children. In other configurations, the application developer may set, for example, a threshold that blocks any advertisement 204 which has an aggregate appropriateness score indicating more than a 25% probability that the advertisement 204 is inappropriate for children.

The application developer may also set one or more thresholds specific for evaluations generated by the text-analysis module 312, the image-fingerprinting module 316, and/or the crowdsourcing module 320. As a further example, the application developer may choose to set a threshold so that the advertisement clearance module 406 blocks any advertisement which receives less than a 5% probability of being appropriate for children from the crowdsourcing module 320. Thus, the application developer may effectively use thresholds to put more weight on results generated by the crowdsourcing module 320 (or any of the other modules). The application developer may freely change the thresholds based on experience gained from actual implementation of the system as well as the application developer's willingness to be under inclusive or over inclusive with regards to clearance of advertisements 204.

An application developer may modify a conventional application 104 in order to obtain the functionality provided by the advertisement evaluation system 112 by adding the advertisement clearance module 406. An operator of the advertisement evaluation system 112 may provide application programming interfaces (APIs) or a software developer kit (SDK) that provides instructions for the application developer to create utilize (e.g., via the APIs) an advertisement clearance module 406 which is capable of communicating with the advertisement evaluation system 112. Additionally or alternatively, an operator of the advertisement evaluation system 112 may provide a service that automatically rewrites the code of the application 104 in order to add the advertisement clearance module 406.

The application 104 may also include, or have access to, a list of advertisement provider services 408. The list of advertisement provider services 408 may specify which advertisement provider services 106 the application developer wishes the application 104 to use for obtaining advertisements 204. The application developer may establish advertising contracts or business relationships with specific application provider services 106. Thus, the application developer may wish to only display advertisements 204 within its application 104 from those advertisement provider services 106. The list of advertisement provider services 408 may include, for example, five different advertisement provider services 106.

Advertisements 204 may be requested from each of the five advertisement provider services in turn using an equally weighted rotation (e.g., round-robin). Thus, each of the five advertisement provider services 106 may supply 20% of the advertisements 204 to the application 104. The application developer may also specify different percentages of advertisements that it wishes to request from each of the individual advertisement provider services 106. These percentages may be included in the list of advertisement provider services 408. For example, if a given advertisement provider service 206 offers larger payments to application developers than other advertisement provider services 206, that advertisement provider service 206 may be designated as the source of 60% of the advertisements 204 and the other four advertisement provider services 206 may each be the source of 10% of the advertisements 204.

The relative preferences for requesting advertisements 204 from advertisement provider services 106 in the list of advertisement provider services 408 may be modified based on the probability that a given advertisement provider service 108 will supply an advertisement 204 that is appropriate for children. The advertisement-provider-service ranking module 328 shown in FIG. 3 may provide percentages of child-inappropriate advertisements 204 coming from each of the advertisement provider services 106 in the list of advertisement provider services 408. The application 104 may select advertisement provider services 106 with relatively higher percentages of advertisements 204 that are inappropriate for children as the source for an advertisement 204 less often than advertisement provider services 106 with relatively lower percentages of advertisements 204 that are inappropriate for children. Thus, the percent of child-inappropriate advertisements 204 provided by an advertisement provider service 108 may be used to weight the frequency of selecting that advertisement provider service 108 from the list of advertisement provider services 408.

This weighting for child-appropriateness of an advertisement provider service 206 may be combined with the preferences of the application developer stored in the list of advertisement provider services 408. For example, if every advertisement provider service 108 included in the list 408 is weighted equally by the application developer and advertisement provider service A is twice as likely to provide an advertisement 204 that is appropriate for children as advertisement provider service B (e.g., 80% child-appropriate for A and 40% child-appropriate for B) then advertisement provider service A may be the source of advertisements 204 twice as often as advertisement provider service B. Other techniques for combining the weighting provided by the application developer and the weighting based on child-appropriateness also possible for creating aggregate weightings of the advertisement provider services 106 in the list 408.

The end-user device 102 may also include one or more network connections 410 that provide access to the network 106 and one or more input/output components(s) 412 such as a keyboard, a pointing device, a touchscreen, a microphone, a camera, a display, a speaker, a printer, and the like.

The ultimate decision of whether or not to display a given advertisement 204 is made by the advertisement clearance module 406. That decision may be based on either a binary evaluation (i.e., appropriate or inappropriate) provided by the advertisement evaluation system 112 or comparison of a numeric value from the advertisement evaluation system 112 to a threshold designated in the advertisement clearance module 406. Although the concept of an advertisement 204 being appropriate or inappropriate for display to children is a subjective evaluation, analysis provided by the text-analysis module 312 using the library of words 314 and analysis provided by the image-fingerprinting module 316 using the library of images 318 enables a machine or computer system to arrive at approximately the same end result. Subjective analysis of “good” and “bad” content or child-appropriate child-inappropriate content may be provided by human editors that select words and phrases for inclusion in the library of words 314 and that select images for inclusion in the library of images 318.

Human intelligence and judgment is utilized in a more direct manner by the crowdsourcing module 320 which solicits responses representing subjective evaluations directly from human evaluators 322. By capturing these responses in a survey or other machine-readable form, the crowdsourcing module 320 is able to present subjective human evaluations in a way that the advertisement evaluation module 310 is able to process. Determinations of acceptable amounts of risk from incorrect classification of an advertisement 204 may also be made by humans. The people who set the thresholds used by the advertisement clearance module 406 and/or the advertisement evaluation module 310 effectively choose the probability with which they are willing to be wrong based on the strictness of the thresholds. Thus, the systems and techniques described in this disclosure enable automated and machine-analysis of a subjective evaluation (i.e., appropriateness for display to children) that would otherwise be difficult to determine without manual characterization of individual advertisements 204. Therefore, “objective child-appropriateness” in this disclosure may be defined as any advertisement that is cleared by the advertisement clearance module 406 to be displayed within the application 104.

However, “subjective child-appropriateness,” as judged by one or more people manually evaluating content, may be different from objective child-appropriateness. Cases in which the subjective child-appropriateness is different from the objective child-appropriateness may be thought of as instances when the machine gives the wrong answer. Wrong answers may be minimized by checking the performance of the advertisement evaluation module 310 against a training set of advertisements that have been previously, manually characterized as appropriate for children or inappropriate for children. Instances in which the advertisement evaluation module 310 returns an incorrect evaluation may be used to adjust the algorithms and relative weights given to the results of the text-analysis module 312, the image-fingerprinting module 316, and the crowdsourcing module 320. Similarly, an application developer that finds inappropriate advertisements 204 being displayed within its application 104, or alternatively finds an unacceptably large number of advertisements 204 being blocked from display, may adjust the thresholds or other characteristics of the advertisement clearance module 406.

### Illustrative Advertisement List and Crowdsourcing Survey

FIG. 5 shows one example of a table 500 of entries stored in the list of advertisements and landing pages 308. The list of advertisement and landing pages 308 may contain hundreds or thousands of entries, but this illustrative table 500 includes only three entries represented by rows 502, 504, and 506. Entries in the list 308 may increase each time a new advertisement 204 is submitted for analysis to the advertisement evaluation module 310. The table 500 may include more columns than those shown and any of the included columns may be omitted.

The list 308 may function as a lookup table that allows an advertisement 204 under evaluation to be compared with records of previously-evaluated advertisements. If a match is found, then the advertisement 204 under evaluation may be characterized the same as the matching entry in the list 308. In some implementations, advertisements 204 that match entries in the list 308 that are designated as inappropriate for children may be automatically designated as inappropriate for children. But advertisements that match entries in the list 308 which are designated as appropriate for children may still be evaluated by the advertisement evaluation module 310.

The table 500 may contain unique advertisement identifiers (Ad ID) for each advertisement 204. Results of analysis performed by the advertisement evaluation module 310 may also be entered in the table 500. A text-based probability score for the text content 206 of the advertisement 204 (ad text score) may represent output from the text-analysis module 312. An image-based probability score for the image content 208 of the advertisement 204 (ad image score) may represent output from the image-fingerprinting module 316. A human-based-analysis probability score for the advertisement 204 (crowdsourcing analysis of ad) may represent output from the crowdsourcing module 320. In this example table 500, the ad text scores and image scores are represented as numerals while the crowdsourcing analysis of the ad is represented as a binary result. However, as discussed above, the entries in columns of the table 500 may be either numerals or binary results depending on the type of output provided by the corresponding analytical modules.

When an advertisement 204 includes a landing page identifier 210, that landing page identifier 210 may be stored in the “landing page for ad” column. Certain landing pages may be blacklisted so that identification of the landing page 212 for an advertisement 204 may be sufficient to characterize the advertisement 204 itself as inappropriate for children. Landing pages 212 that are webpages on the World Wide Web may be characterized by top level domain, geographic location of page owners, and other features. For example, any landing page 212 with the top level domain .xxx may be classified as inappropriate for children without further analysis. Similarly, landing pages 212 that have owners (i.e., identified by WHOIS listings) with certain characteristics such as an address in a particular country or region, or an anonymous WHOIS listing may be automatically classified as inappropriate for children. Thus, any advertisement 204 that includes a landing page identifier 210 for a blacklisted or inappropriate landing page may be quickly identified as an inappropriate advertisement. Thus, certain advertiser techniques of creating new advertisements for the same landing pages 212 may be rendered ineffective.

The text content 214 and image content 216 of the landing page 212 may also be analyzed by the text-analysis module 312, image-fingerprinting module 316, and crowdsourcing module 320. Results of these analyses may be entered in the “landing page text score” column, “landing page image score” column, and “crowdsourcing analysis of landing page” column respectively.

A percentage of inappropriate advertisements coming from an advertisement provider service 108 (APS) that provided an advertisement 204 in the list 308 may also be stored in the table 500 (inappropriate ad % of APS). This column may be populated with output from the advertisement-provider-service ranking module 328.

Generally, if any aspect of an advertisement 204 is deemed inappropriate for children—even if some characteristics of the advertisement 204 are deemed appropriate for children—then the entire advertisement 204 may be labeled as inappropriate for children. In the table 500 the numerical values may represent probabilities that content is inappropriate for children. Lower numbers represent lower probabilities or percentages of content being inappropriate. Thus, lower numbers indicate “better” content for children.

Thus, in this example table 500, row 502 represents an advertisement 204 that has a relatively low probability of the text and images in the advertisement being inappropriate. Crowdsourcing analysis indicates that the advertisement 204 is appropriate for children. Also, the landing page has relatively low probabilities of text content 214 and image content 216 being inappropriate for children. Although there is a 20% probability that the image content 216 may be inappropriate, this probability may be low enough, depending on the thresholds, to allow the advertisement 204 to be shown to children. Also, crowdsourcing analysis of the landing page 212 indicates that it is appropriate for display to children. Moreover the advertisement provider service 108 that is the source of this advertisement 204 provides no (0%) advertisements 204 that are inappropriate for children. Therefore, the advertisement 204 represented by the entries in row 502 may be deemed appropriate to show to children.

The advertisement 204 represented by row 504, has higher values for the text score and image score. However, crowdsourcing analysis of the advertisement indicates that the advertisement 204 is appropriate for display to children. These results may indicate that the text content 206 and image content 208 in the advertisement 204 contains features that the text-analysis module 312 and the image-fingerprinting module 316 associate with inappropriate content yet is not inappropriate based on human-analysis. Thus, the advertisement 204 may itself be appropriate for display to children. The landing page 212 associated with this advertisement 204 has a higher landing page text score of 70. Also, crowdsourcing analysis indicates that the landing page 212 is inappropriate for children. Thus, because the landing page 212 is likely inappropriate, the advertisement represented by row 504 may be blocked from display to children.

The advertisement represented by row 506 of the illustrative table 500 has high scores for the inappropriateness of the advertisement 204 as well as the landing page 212. Thus, this advertisement 204 would likely be blocked by the advertisement clearance module 406 in an end-user device 102 using this system. Additionally, the table 500 shows that 90% of the advertisements 204 provided by the advertisement provider service 108 which supplied the advertisement 204.

The list of advertisements and landing pages 308 represents results of past analyses performed by the advertisement evaluation system 112. Use of these past analyses may reduce processing time and provide faster results than evaluating the text, images, and soliciting crowdsourcing analysis. Also, because the advertisement evaluation system 112 may interact with multiple different end-user devices 102 and multiple different advertisement provider services 106, any application 104 using the advertisement evaluation system 112 receives the benefit of a large pool of knowledge (i.e., data stored in the list 308).

FIG. 6 shows an illustrative survey 600 that may be sent to human evaluators 322 by the crowdsourcing module 320. This example survey 600 asks eight different questions about the contents of a landing page 212 (www.xyz.com). Contents of surveys or other queries sent from the crowdsourcing module 320 may include different questions than those included in this example, more questions than are included in this example, or only a single question. For example, the single question may ask for a yes or no answer to the question: “Is this webpage appropriate for children?” Alternatively, a survey may ask for something other than a yes or no answer such as: “Rate how appropriate this webpage is for children from 1-5 with 5 being very appropriate and 1 being very inappropriate.” A survey may also ask human evaluators 322 to indicate the ages of users for which the webpage is appropriate. For example, a human evaluator 322 may be allowed to select numbers from 0 to 18 to indicate which are appropriate ages for recipients of a given advertisement. In some implementations, the survey 600 may be presented to the human evaluators 322 as a webpage.

The human evaluators 322 who respond to the survey 600 may not have training in evaluation of appropriateness of content for children. Thus, the survey 600 may include more specific questions that are less subjective and likely to be answered consistently even by a variety of human evaluators 322 with different opinions and different backgrounds. For example, the survey 600 may specifically ask such things as if a webpage contains sexual or sexual suggestive of content and the survey 600 may also ask if the webpage contains profanity. With these types of specific questions the type of inappropriate content as well as the presence of inappropriate content can be identified through crowdsourcing.

The survey 600 and use of crowdsourcing may also be appropriate for determining if a website solicits personal information or otherwise provides opportunities for a child to communicate a way that may lead to the child revealing personal information. For example, in addition to asking if the webpage request users' personal information, the survey 600 may also provide a list of specific types of personal information and ask which of those are requested by the webpage. The type of information and granularity of information collected by a survey or other type of query is limited only by the types of questions included. Although the survey 600 includes questions about the content of a landing page 212, a query to the human evaluations 322 may include questions about the content of an advertisement 204.

### Illustrative Processes

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process, or an alternate process. Moreover, it is also possible that one or more of the provided operations may be modified or omitted.

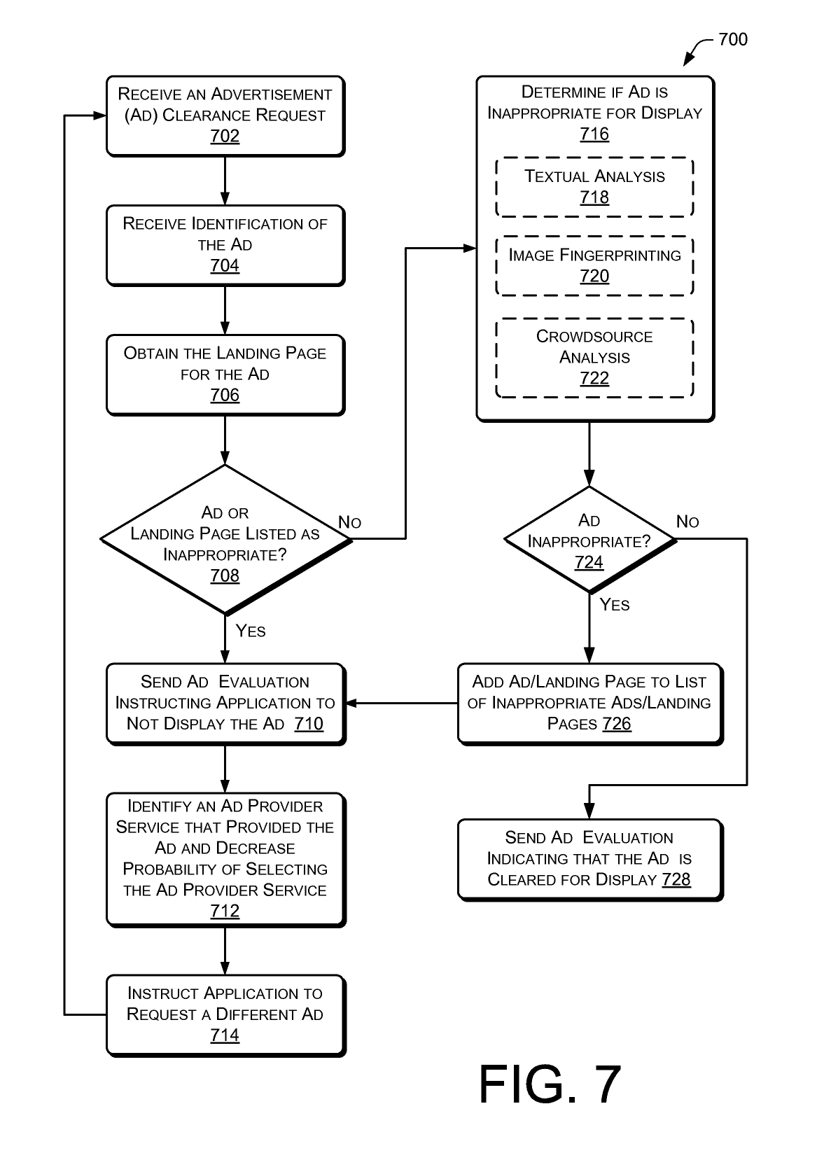

FIG. 7 shows an illustrative process 700 for determining if an advertisement is appropriate or inappropriate for a target age group such as children. This process 700 may be performed in whole or part by the advertisement evaluation system 112.

At 702, an advertisement (ad) clearance request is received from an application to evaluate the appropriateness of an advertisement for display to the target age group. The application may be the application 104 shown in FIGS. 1 and 4.

At 704, identification of the advertisement may be received from the application. The identification of the advertisement may be the ad info 202 shown and described FIG. 2. This information may enable retrieval of the advertisement 204 from an advertiser 110.

At 706, a landing page for the advertisement may be obtained from an advertiser that generated the advertisement. In some implementations, receiving ad info 202 enables obtaining the advertisement 204 which may include a landing page identifier 210 that is used to obtain the landing page 212 as shown in FIG. 2.

At 708, it is determined if the advertisement or the landing page are included in a list of inappropriate advertisements or landing pages. When either the advertisement or the landing page is included in a list of inappropriate advertisements/landing pages it may be determined that the advertisement is inappropriate for the target age group. In some implementations, the list of inappropriate advertisements and the list of inappropriate landing pages may be configured as a list of advertisements and landing pages 308 shown in FIGS. 3 and 5.

If at 708, the advertisement is determined to be inappropriate for the target age group and process 700 proceeds along the “yes” path to 710. However, if both the advertisement and the corresponding landing page are not found to be inappropriate based on comparison to the list, then the process 700 proceeds along the “no” path to 716.

At 710, an advertisement evaluation instruction is sent to the application instructing the application to not display the advertisement. Thus, the when the application acts on these instructions, the advertisement is blocked from display and is not capable of being viewed by users of the application.

At 712, an advertisement provider service that provided the advertisement is identified and the probability of selecting the advertisement provider service as a source of advertisements is decreased. Thus, advertisement provider services which provide advertisements that are inappropriate for the target age group are less likely to receive future requests to supply advertisements.

At 714, instructions to request a different advertisement are sent to the application. The application may act on these instructions, request, and receive a new advertisement, then the process 700 may return to 702 where an advertisement clearance request is received for this new advertisement.

If however, the advertisement or corresponding landing page was not included in the list of inappropriate advertisements or landing pages, the process 700 proceeds from 708 to 716.

At 716, it is determined if the advertisement is inappropriate for display to the target age group. Determination may be based on text analysis 718 of words in the advertisement or the landing page for the advertisement, image fingerprinting 720 of images in the advertisement or the landing page, and/or crowdsource analysis 722 of the advertisement or the landing page. If any of the analyses 718, 720, or 722 determined that the advertisement or the landing page is inappropriate for display, then determination made at 716 may classify the advertisement is appropriate for display to the target age group.

The textual analysis performed at 718 compares words found in the advertisement or in the landing page to a library of known inappropriate words and determines that the advertisement is inappropriate for the target age group when a word from the library is found in either the advertisement or in the landing page. The textual analysis at 718 may be performed by the text-analysis module 312 using the library of words 314.

The image fingerprinting performed at 720 compared images found in the advertisement or the landing page to a library of known inappropriate images and determines that the advertisement is inappropriate for the target age group when an image from the library or an image having a similar image fingerprint to an image in the library is found in the advertisement or in the landing page. The image fingerprinting at 720 may be performed by the image-fingerprinting module 316 using the library of images 318.

The crowdsource analysis performed at 722 receives responses to a query asking human evaluators if the advertisement or the landing page contains content that is inappropriate for the target age group. The query may be formulated as a survey that is the same or similar to the survey 600 shown in FIG. 6. The crowdsource analysis 322 determines that the advertisement is inappropriate for the target age group when more than a threshold amount of the human evaluators who respond to the query indicate that either the advertisement or the landing page contains content that is inappropriate for the target age group. The threshold amount of human evaluators may be based on a number of responses or percentage of responses. For example, if the threshold is set at 50 responses and more than 50 people respond to the query indicating that either the advertisement or the landing page contains content that is inappropriate for the target age group, then the advertisement is determined to be inappropriate for the target age group. In other implementations, if the threshold is set as more than 30% of respondents, and 20 out of 60 people (33%) who respond to the query indicate that either the advertisement or the landing page contains content that is inappropriate for the target age group, then the advertisement is determined to be inappropriate for the target age group. The crowdsource analysis 322 may be performed by the crowdsourcing module 322.

At 724, the advertisement is determined to be inappropriate or appropriate for display to the target age group. When the advertisement is determined to be inappropriate for the target age group, the process 700 proceeds from 724 along the “yes” path to 726. If the advertisement is determined to be appropriate for the target age group, the process 700 proceeds from 724 along the “no” path to 728.

At 726, the advertisement and/or the landing page are added to the list of inappropriate advertisements or to a list of inappropriate landing pages. The list of inappropriate advertisements in the list of inappropriate landing pages may be the same list or lists referenced at 708. In some implementations, addition of an advertisement or landing page to the list may consist of adding another row to the table 500 shown in FIG. 5.

The process 700 proceeds from 726 to 710 and repeats the acts described above.

At 728, when the determining at 716 indicates that the advertisement is appropriate for display to the target age group, an advertisement evaluation is sent to the application indicating that the advertisement is cleared for display to the target age group.

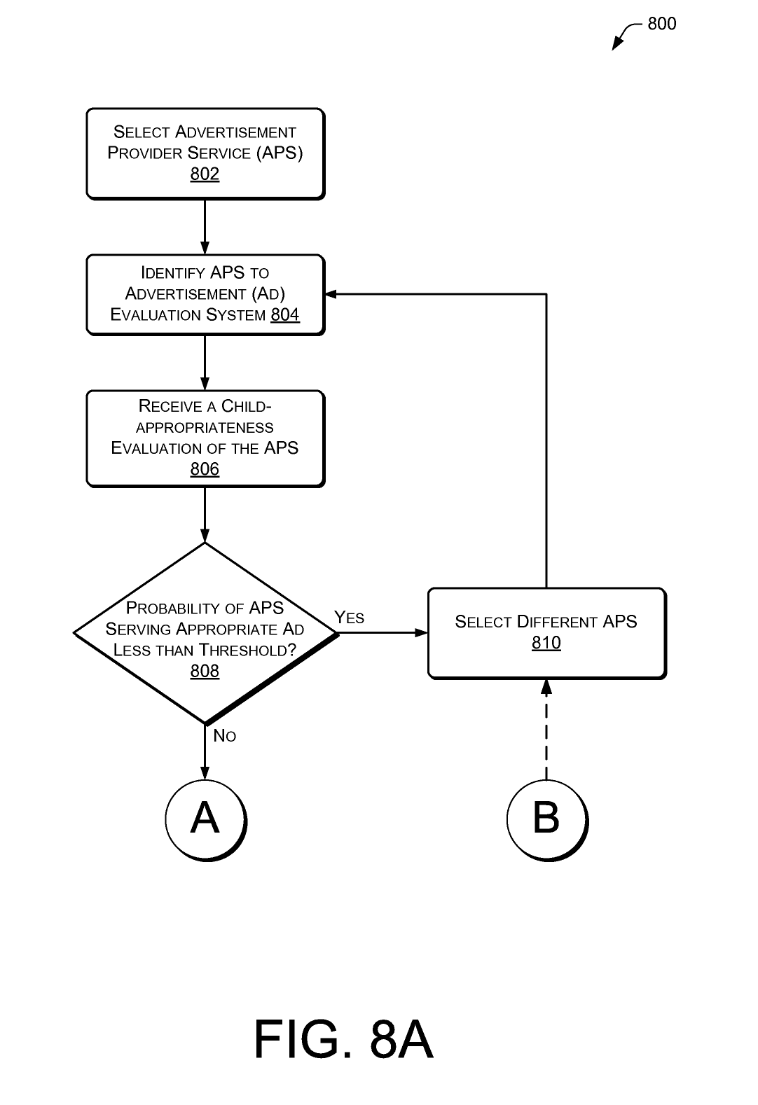

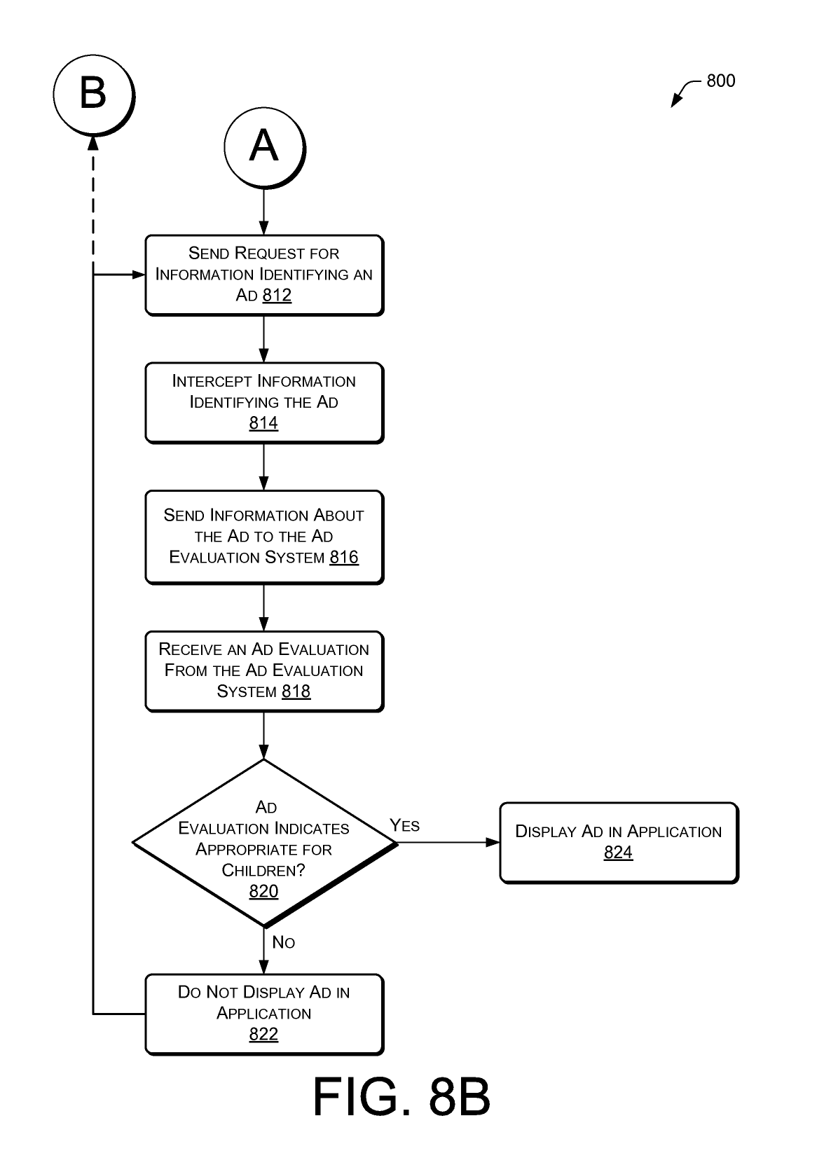

FIGS. 8A and 8B show an illustrative process 800 for determining if an advertisement should or should not be displayed in an application. This process 800 may be performed whole or part by the advertisement clearance module 406 in the application 104 on the end-user device 102.

At 802, the advertisement provider service (APS) is selected from a list of advertisement provider services. The list of advertisement provider services may be the list 408 shown in FIG. 4.

Individual ones of the advertisement provider services in the list may be associated with preference weightings that affect a frequency with which the individual ones of advertisement provider services are selected. The preference weightings may be specified by the application developer. A weighting indicates how often particular advertisement provider services should be asked to provide an advertisement for display inside the application. For example, if the list of advertisement provider services includes two different advertisement provider services, the first may be weighted so that it receives 80% of the requests and a second weighted so that it receives 20% of the requests. Other relative weightings, including equal weightings, are also possible.

Individual ones of the advertisement provider services in the list may also be associated with child-appropriateness weightings based on a probability that advertisements served from the advertisement provider service are appropriate for display to children. The selection performed at 802 may be additionally based on the child-appropriateness weightings in combination with the preference weightings. Thus, the list 408 present on the end-user device 102 may include two separate weightings (i.e., preference weightings and child-appropriateness weightings) for each advertisement provider service in that list.

At 804, the selected advertisement provider service is identified to the advertisement evaluation system. This identification may include providing the name or other identifier of the advertisement provider service to the advertisement evaluation system.

At 806, a child-appropriateness evaluation of the advertisement provider service is received from the advertisement evaluation system. The child appropriateness evaluation indicates a probability that advertisements served from the advertisement provider service are appropriate for display to children. For example, a given advertisement provider service has an 80% probability of serving advertisements that are appropriate for children. The child-appropriateness evaluation may be generated at the advertisement evaluation system 112 by the advertisement-provider-service evaluation module 326 shown in FIG. 3.

The evaluation of child appropriateness received from the advertisement evaluation system may be used when the list of advertisement provider services available to the application does not include child-appropriateness weightings. Alternatively, the evaluations received from the advertisement evaluation system may be used to replace or update weightings stored in the list available to the application.

At 808, the probability of an application provider service serving an advertisement that is appropriate for children is compared to a threshold probability. The threshold probability may be arbitrarily set at any percentage level to exclude advertisement provider services that have a low likelihood of providing child-appropriate advertisements. For example, the threshold may be set to exclude advertisement provider services that have less than 40% likelihood of providing child-appropriate advertisements.

When the child-appropriateness evaluation received at 806 indicates less than a threshold probability that the advertisements are appropriate for display to children, the process 800 proceeds along the “yes” path to 810. When the child-appropriateness evaluation indicates more than the threshold probability that advertisements from the advertisement provider service are appropriate for display to children, the process 800 proceeds along the “no” path to 812 shown on FIG. 8B.

At 810, a different advertisement provider service from which to request the advertisement is selected. The process 800 may return from 810 to 804 where the different advertisement provider service that has been selected is identified to the advertisement evaluation system. Thus, this portion of the process may repeat until an acceptable advertisement provider service has been selected.

At 812, a request for information identifying an advertisement is sent from the application to the advertisement provider service selected at 802 (or at 810 if the advertisement provider service selected initially had less than the threshold probability of serving a child-appropriate advertisement). This request may be an initial act in the process of obtaining an advertisement to display in the application.

At 814, information identifying the advertisement that is served from the advertisement provider service in response to the request at 812 is intercepted by the advertisement clearance module 406. The information identifying the advertisement may be the advertisement itself, an image displayed in the advertisement, a landing page reached by a user upon interacting with the advertisement, other identifying data such as a name or unique identification number of the advertisement, or any combination of these or similar types of information. The information identifying the advertisement may be the ad info 202 shown in FIG. 2. The intercepting occurs prior to display of the advertisement in the application. This provides an opportunity for the advertisement evaluation system 112 to evaluate the advertisement prior to potentially displaying the advertisement to children.

At 816, the information about the advertisement received at 814 is sent by the end-user device to the advertisement evaluation system. As shown in FIG. 1, this information may be sent via the network 106. If the information is the advertisement itself, then a copy of the advertisement is sent from the end-user device to the advertisement evaluation system at 816. If, in other implementations, the information is a name or identifier of the advertisement, that name or identifier is sent to the advertisement evaluation system and then the advertisement evaluation system obtains the advertisement for evaluation.

At 818, an evaluation for the advertisement is received from the advertisement evaluation system. The evaluation may be provided by the advertisement evaluation module 310. In one implementation, the advertisement clearance module 406 may receive a binary evaluation indicating that the advertisement is either appropriate for children or inappropriate from children. In other implementations, the evaluation may be a number indicating a probability that the advertisement is inappropriate (or appropriate) for display to children. That number may be compared to a threshold established by the application developer so that the final decision about appropriate or inappropriate is made at the end-user device rather than the advertisement evaluation system.

The evaluation received at 818 may include a probability that text in the advertisement or a landing page for the advertisement is inappropriate for children, a probability than an image in the advertisement or the landing page is inappropriate for children, or a plurality of responses from human evaluations indicating that the advertisement or the landing page is inappropriate for children. Each of these three probabilities may be reported separately as numbers or percentages. Thus, the advertisement clearance module 406 may interpret each probability separately.

At 820, it is determined if the advertisement evaluation received at 818 indicates that the advertisement is appropriate or inappropriate for children. When the advertisement evaluation indicates that the advertisement is inappropriate to display to children, the process 800 proceeds along the “no” path to 822. When the advertisement evaluation indicates that the advertisement is appropriate to display to children, the process 800 proceeds along the “yes” path to 824.

If the advertisement evaluation system provides probabilities of the text, the images, and crowdsourced judgment, indicating that the advertisement is inappropriate for children, interpretation of the advertisement as inappropriate or appropriate may be based on comparison of one or more of these probabilities to a threshold probability. Exceeding the threshold probability may thus be interpreted by the advertisement clearance module 406 as indicating that the advertisement is inappropriate for display to children.

At 822, the advertisement is not displayed and a request is sent for another advertisement. The request may be directed to the same advertisement provider service that supplied the advertisement which was just determined to be inappropriate for children. In this implementation, the process 800 proceeds from 822 back to 812 where another request for information identifying an advertisement is sent to the same advertisement provider service. In another implementation as shown by the dashed line, the process 800 may return to an earlier stage going from 822 back to 810 on FIG. 8B. At 810, an advertisement provider service is selected and the process 800 proceeds as described above. A different advertisement service may be less likely to supply the same inappropriate advertisement identified at 818 than the advertisement provider service used earlier. However, it is possible that two (or more) different advertisement provider services may supply the same advertisement.

At 824, the advertisement is displayed in the application. Displaying the advertisement may include requesting an advertiser to send the advertisement to the end-user device and receiving the advertisement from the advertiser. Recall, as shown in FIG. 2, that the advertisement provider service 108 may provide only ad info 202 and the advertiser 110 may be the entity that supplies the advertisement 204 to the end-user device 102. Once the end-user device 102 has obtained the advertisement 204 from the advertiser 110, the application 104 may be able to display the advertisement 204. When the advertisement is displayed and/or interacted with by a user (e.g. “clicked”), the application developer may receive revenue from the advertisement provider service according to a contract or business arrangement between the application developer and the advertisement provider service.

### CONCLUSION

Although the subject matter has been described in language specific to structural features and/or methodological acts, it is to be understood that the subject matter defined in the appended claims is not necessarily limited to the specific features or acts described above. Rather, the specific features and acts are disclosed as example forms of implementing the claims.

1. A computing system comprising;
one or more processing units;
one or more network connections, in communication with the one or more processing units, configured to receive advertisement clearance requests via a network from end-user devices and transmit advertisement evaluations via the network to the end-user devices;
an advertisement identification module, in communication with the one or more processing units, configured to receive identification of an advertisement from an end-user device via the one or more network connections and determine a landing page reached by a user upon interacting with the advertisement;
a text-analysis module, in communication with the one or more processing units, configured to determine if the advertisement or the landing page includes text that is identified as inappropriate for children;
an image-fingerprinting module, in communication with the one or more processing units, configured to determine if the advertisement or the landing page includes an image that is the same or similar to an image identified as inappropriate for children;
a crowdsourcing module, in communication with the one or more processing units, configured to determine a collective evaluation of appropriateness of the landing page for children from an aggregation of a plurality of responses; and
an advertisement evaluation module, in communication with the one or more processing units, configured to generate an advertisement evaluation for the advertisement based at least in part on results from the text-analysis module, the image-fingerprinting module, and the crowdsourcing module.

2. The computing system of claim 1, wherein the text-analysis module outputs a text-based probability score that the advertisement is inappropriate for children, wherein the image-fingerprinting module outputs an image-based probability score that the advertisement is inappropriate for children, and the crowdsourcing module outputs a human-analysis-based probability score that the advertisement is inappropriate for children; and
wherein the advertisement evaluation generated by advertisement evaluation module is an aggregate probability score that the advertisement is inappropriate for children based at least in part on the text-based probability score, the image-based probability score, and the human-analysis-based probability score.

3. The computing system of claim 1, wherein the crowdsourcing module is further configured to:
transmit, to a plurality of human evaluators, a query asking if the landing page asks for personal information;
to receive a plurality of responses to the query from the plurality of human evaluators.

4. The computing system of claim 1, wherein the advertisement identification module is further configured to determine an advertisement provider service that provided the advertisement; and
the computer system further comprising:
an advertisement-provider-service evaluation module, in communication with the one or more processing units, configured to log instances that the advertisement provider service provides an advertisement that is inappropriate for children and to determine a percentage of total advertisements provided by the advertisement provider service that are inappropriate for children; and
an advertisement-provider-service ranking module, in communication with the one or more processing units, configured to send to the end-user devices the percentage of total advertisements provided by the advertisement provider service that are inappropriate for children for use by the end-user devices in selecting an advertisement provider service.

5. A method comprising:
receiving an advertisement clearance request from an application to evaluate the appropriateness of an advertisement for display to children;
determining if the advertisement is inappropriate for display to a target age group based on analysis of advertising content of the advertisement or the landing page; and
sending, to the application, an advertisement evaluation of the advertisement based at least in part on the determining.

6. The method of claim 5, wherein the advertisement evaluation comprises instructions to the application to not display the advertisement and to request a different advertisement when the determining indicates that the advertisement is inappropriate for display to the target age group; or
wherein the advertisement evaluation comprises an indication that the advertisement is cleared for display to the target age group when the determining indicates that the advertisement is appropriate for display to the target age group.

7. The method of claim 5, wherein analysis of advertising content comprises at least one of (i) textual analysis of words in the advertisement or a landing page for the advertisement, (ii) image fingerprinting of images in the advertisement or the landing page, or (iii) crowdsource analysis of the advertisement or the landing page.

8. The method of claim 7, wherein the determining is based on at least (i) the textual analysis of words in the advertisement or the landing page; and
wherein the textual analysis compares words found in the advertisement or in the landing page to a library of known inappropriate words for the target age group and determines that the advertisement is inappropriate for the target age group when a word from the library is found in the advertisement or in the landing page.

9. The method of claim 7, wherein the determining is based on at least (ii) the image fingerprinting of the images in the advertisement or the landing page; and
wherein the image fingerprinting compares images found in the advertisement or in the landing page to a library of known inappropriate images for the target age group and determines that the advertisement is inappropriate for the target age group when an image from the library or an image having a similar image fingerprint to an image in the library is found in the advertisement or in the landing page.

10. The method of claim 7, wherein the determining is based on at least (iii) the crowdsource analysis of the advertisement or the landing page; and
wherein the crowdsource analysis receives responses to a query asking human evaluators if the advertisement or the landing page contains content that is inappropriate for the target age group and determines that the advertisement is inappropriate for the target age group when more than a threshold amount of the human evaluators who respond to the query indicate that either the advertisement or the landing page contains content that is inappropriate for the target age group.

11. The method of claim 5, further comprising:
receiving identification of the advertisement from the application;
obtaining the landing page for the advertisement from an advertiser that generated the advertisement; and
determining if the advertisement is appropriate for display to the target age group based on analysis of advertising content of the landing page.

12. The method of claim 5, further comprising:
when the determining indicates that the advertisement is inappropriate for the target age group, adding the advertisement to a list of inappropriate advertisements;
when the determining indicates that the landing page is inappropriate for the target age group, adding the landing page to a list of inappropriate landing pages;
receiving a later advertisement clearance request for a later advertisement; and
determining that the later advertisement is inappropriate for the target age group when the later advertisement is included in the list of inappropriate advertisements or when a landing page for the later advertisement is included in the list of inappropriate landing pages.

13. Computer storage media storing information that, when accessed by a computing device, instructs the computing device to perform the acts of:
intercepting information identifying an advertisement that is served from an advertisement provider service, the intercepting occurring prior to display of the advertisement in an application on the computing device;
sending information about the advertisement to an advertisement evaluation system;
receiving an advertisement evaluation for the advertisement from the advertisement evaluation system;
when the advertisement evaluation indicates that the advertisement is appropriate to display to children, displaying the advertisement in the application; and
when the advertisement evaluation indicates that the advertisement is inappropriate to display to children, not displaying the advertisement and sending a request for another advertisement.

14. The media of claim 13, wherein the information identifying the advertisement comprises at least one of the advertisement itself, an image displayed in the advertisement, or a landing page reached by a user upon interacting with the advertisement.

15. The media of claim 13, wherein the advertisement evaluation comprises at least one of (i) a probability that text in the advertisement or landing page for the advertisement is inappropriate for children, (ii) a probability that an image in the advertisement or the landing page is inappropriate for children, or (iii) a plurality of responses from human evaluators indicating that the advertisement or the landing page contains content that is inappropriate for children.

16. The media of claim 15, wherein the information instructs the computing device to perform the further acts of interpreting the advertisement evaluation as indicating that the advertisement is inappropriate to display to children when (i) the probability that text in the advertisement or landing page for the advertisement is inappropriate for children exceeds a threshold probability, (ii) the probability that the image in the advertisement or the landing page is inappropriate for children exceeds a threshold probability, or (iii) more than a threshold amount of the plurality of responses from the human evaluators indicates that the advertisement or the landing page is inappropriate for children.

17. The media of claim 13, wherein displaying the advertisement in the application comprises requesting an advertiser to send the advertisement to the computing device and receiving the advertisement from the advertiser.

18. The media of claim 13, wherein the information instructs the computing device to perform the further acts of selecting the advertisement provider service from which to request an advertisement from a list of advertisement provider services, individual ones of the advertisement provider services in the list associated with preference weightings that affect a frequency with which the individual ones of the advertisement provider services are selected.

19. The media of claim 18, wherein the individual ones of the advertisement provider services in the list are associated with child-appropriateness weightings based on a probability that advertisements served from the advertisement provider service are appropriate for display to children and the selecting is based on a combination of the preference weightings and the child-appropriateness weightings.

20. The media of claim 13, wherein the information instructs the computing device to perform the further acts of:
selecting the advertisement provider service from which to request an advertisement;
identifying the advertisement provider service to the advertisement evaluation system;
receiving a child-appropriateness evaluation of the advertisement provider service from the advertisement evaluation system, the child-appropriateness evaluation indicating a probability that advertisements served from the advertisement provider service are appropriate for display to children;
when the child-appropriateness evaluation indicates less than a threshold probability that the advertisements are appropriate for display to children, selecting a different advertisement provider service from which to request the advertisement; and
when the child-appropriateness evaluation indicates more than a threshold probability that the advertisements are appropriate for display to children, sending a request for the information identifying the advertisement to the advertisement provider service.
